(19) United States
(12) Patent Application Publication
(10) Pub. No.: US 2025/0074702 A1
(43) Pub. Date: Mar. 6, 2025

(54) AUTOMATED LOAD HANDLING DEVICES AND SYSTEM

(71) Applicant: Dematic Corp., Grand Rapids, MI (US)

(72) Inventor: Daniel Howarth, Grosse Ile, MI (US)

(21) Appl. No.: 18/821,337

(22) Filed: Aug. 30, 2024

Related U.S. Application Data
(60) Provisional application No. 63/535,602, filed on Aug. 31, 2023.

(51) Int. Cl. B65G 1/06; B25J 11/00; B65G 1/137; B65G 61/00

(52) U.S. Cl. CPC B65G 1/065; B25J 11/008; B65G 1/1373; B65G 61/00

(57) ABSTRACT

A material handling system includes a storage apparatus having a frame and a plurality of storage shelves, with the frame configured to support the plurality of storage shelves on a floor, and an automated load handling device having a base configured to be a supported on and for movement across the floor, and the automated load handling device including a stabilizing member configured to engage the storage apparatus to stabilize the automated load handling device.

### CROSS REFERENCE TO RELATED APPLICATION

The present application claims the priority benefit of U.S. provisional patent application Ser. No. 63/535,602, filed on Aug. 31, 2023, the disclosure of which is hereby incorporated by reference in its entirety.

### TECHNICAL FIELD

The present disclosure generally relates to automated load handling devices, and more particularly to automated load handling devices that deliver and retrieve loads to and from a storage apparatus, such as one or more storage racks.

### BACKGROUND

Automated load handling devices include a variety of loading handling devices, including autonomous mobile robots, often referred to as AMRs, automatic guided vehicles, often referred to as AGVs, advanced motor control systems, often referred to as ACRs, as well as forklifts, which are usually driverless vehicles that are often used for material handling purposes. These loading handling devices are capable of carrying articles from one point to another without the need for a driver on the vehicle and, further, are typically capable of driving themselves from a first location to a second location, such as by using navigational sensors to determine their position and heading and to safely navigate around people, equipment, and inventory.

Some automated loading handling devices may have an extendable load support, such as a fork that is mounted for vertical movement to reach higher elevations, for example up to 7-10 meters, which increase the height range of the automated loading handling devices. Other automated loading handling devices may have an extendable load support in the form of a robotic arm, which increases the range and reach of the automated loading handling devices. However, at increased heights and increased reach the automated loading handling devices may be subject to swaying, which could affect the stability and accuracy of the loading handling devices when handling heavy loads.

### SUMMARY

According to one aspect of the present disclosure, a material handling system includes a storage apparatus having a frame and a plurality of storage shelves, with the frame configured to support the plurality of storage shelves on a floor, and an automated load handling device having a base configured to be a supported on and for movement across the floor, and the automated load handling device including a stabilizing member configured to engage the storage apparatus to stabilize the automated load handling device.

According to another form, an automated load handling device includes a base and an extendible load support that is mounted to the base to support a load, such as a pallet, tote or container. The automated load handling device also includes a deployable stabilizing that is configured when deployed to engage a storage apparatus to stabilize the automated load handling device when automated load handling device is adjacent the storage apparatus and configured to deliver or retrieve a load from the storage apparatus.

In accordance with a particular aspect of the disclosure, the automated load handling device includes an extendible load support that is extendible or moveable relative to the base. In one form the stabilizing member is mounted relative to the extendible load support to move with the extendible load support. In a particular configuration the stabilizing member is movably mounted to the extendible load support, and may optionally be movable between a stowed position and a deployed position with the stabilizing member being configured to engage the storage apparatus in the deployed position.

According to still a further particular aspect, the storage apparatus includes a rail mounted relative to the frame of the storage apparatus with the stabilizing member being configured to engage the rail.

Additionally or alternatively, the stabilizing member may be configured to couple to the storage apparatus. In a particular embodiment the stabilizing member includes a lock to relcasably lock the stabilizing member to the storage apparatus.

According to a further aspect of the disclosure, the extendible load support comprises a robotic arm.

In still a further aspect, the storage apparatus comprises a pair of storage apparatuses separated by an aisle with the automated load handling device configured to traverse the aisle between the storage apparatuses with the stabilizing member configured to engage at least one of the storage apparatuses to stabilize the automated load handling device. Optionally the automated load handling device may comprise a pair of stabilizing members with each stabilizing member configured to engage a separate one of the storage apparatuses.

According to yet another aspect of the disclosure, a method of stabilizing a load handling device in position adjacent an adjacent storage apparatus comprises providing the load handling device with at least one stabilizing member, positioning the stabilizing member to contact the adjacent storage apparatus or another storage apparatus next to the adjacent storage apparatus, and contacting the adjacent storage apparatus or other storage apparatus with the stabilizing member to facilitate stabilizing the load handling device.

In a particular form, the positioning includes pivoting the stabilizing member between a stowed position and a deployed position where the stabilizing member is positioned to contact the storage apparatus. Optionally, the positioning may further include extending the length of the stabilizing member. Still further, contacting with the stabilizing member may comprise engaging the adjacent storage apparatus or other storage apparatus with the stabilizing member.

According to still a further aspect the method may include providing a rail on the adjacent storage apparatus or other storage apparatus, with the engaging including engaging the rail with the stabilizing member. Alternatively and/or optionally, the engaging may further comprise locking the stabilizing member to the adjacent storage apparatus or other storage apparatus.

According to still a further embodiment, a method of stabilizing a load handling device located between two opposed storage apparatuses comprises providing the load handling device with at least one stabilizing member, positioning the stabilizing member to contact one of the opposed storage apparatus, and contacting the one of the opposed storage apparatuses with the stabilizing member to facilitate stabilizing the load handling device.

In a particular form the load handling device is provided with two stabilizing members, and the contacting includes contacting both opposed storage apparatuses with the stabilizing members, which may include engaging at least one of the opposed storage apparatuses.

The material handling system in accordance with the present disclosure provides a system and method for stabilizing an automated load handling device relative to a storage apparatus. The thus stabilized system provides improved security and accuracy for storing and removing goods from the storage apparatus. These and other objects, advantages, purposes, and features of the present invention will become apparent upon review of the following specification in conjunction with the drawings.

### BRIEF DESCRIPTION OF THE DRAWINGS

FIG. 1 is a perspective view of a material handling system with a storage apparatus and an automated load handling device;

FIG. 2 is a perspective view of the automated load handling device of FIG. 1 with a robotic arm;

FIG. 3 is a perspective view of another embodiment of an automated load handling device shown adjacent a storage apparatus;

FIG. 4 is an enlarged perspective view of the automated load handling device of FIG. 3 with the shuttle lowered to its fully lowered position;

FIG. 5 is a similar view to FIG. 4 with the shuttle in its fully raised position illustrating a pair of extended stabilizing members.

FIG. 6 is a similar view to FIG. 5 with the shuttle in its fully raised position illustrating a single stabilizing member;

FIG. 7 is a perspective view of yet another embodiment of an automated load handling device shown between two storage apparatus; and

FIG. 8 is a partial view of a telescoping stabilizing member having a retractable and extendable pin.

### DETAILED DESCRIPTION OF EMBODIMENTS

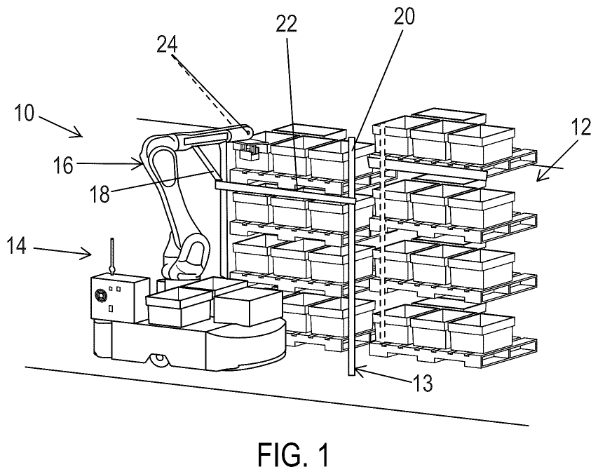

Referring to FIG. 1, the numeral 10 generally designates a material handling system. In the illustrated embodiment, material handling system 10 includes a storage apparatus 12, such as a storage rack 13 having multiple shelves, and an automated load handling device 14, such as an automated mobile robot (AMR) as illustrated, which may alternatively comprise an automatic guided vehicles (AGV), an advanced motor control system (ACR), as well as a forklift. The automated load handling device 14 includes an extendable load support 16, such as a robotic arm or fork, which is used to deliver or retrieve loads from the storage apparatus 12. As will be more fully described below, automated load handling device 14 is adapted to reduce the degrees of freedom of the extendable load support 16 when the extendable load support is extended (either raised and/or extended outwardly) to stabilize the automated load handling device 14.

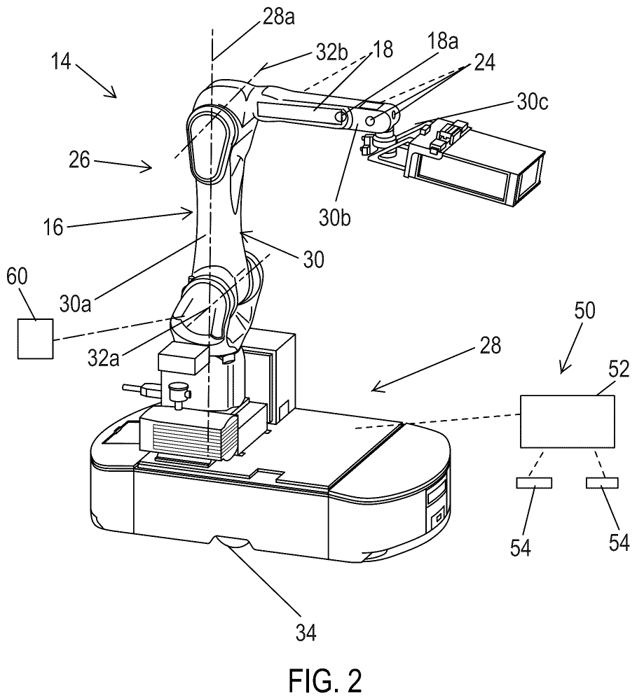

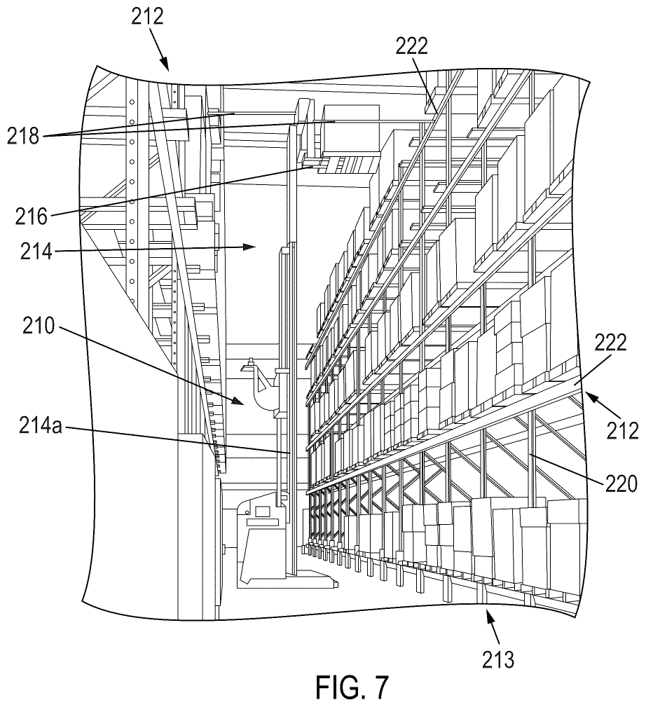

As best seen in FIG. 1, automated load handling device 14 is provided with one or more stabilizers or stabilizing members 18 that are mounted to automated load handling device 14 and moved to a stowed position, such as shown in FIG. 2, or to a deployed position, such as shown in FIG. 1. When deployed, stabilizing members 18 are configured and positioned to engage the storage apparatus 12 to reduce one or more degrees of freedom of automated load handling device 14, and thereby increase the stability of the automated load handling device 14 but without necessarily increasing the footprint of the automated load handling device. Although illustrated as engaging only the adjacent rack, the automated load handling device 14 may engage another rack that is next to the adjacent rack. Further, as will be more fully described below in reference to FIG. 7, the automated load handling device 14 may be located between two racks and engage both racks, or may be located between two racks and only engage one rack.

The engagement between stabilizing member 18 and the storage apparatus 12 may be between the stabilizing member 18 and a frame 20 of the storage apparatus 12 or between the stabilizing member 18 and a rail 22 mounted to the frame 20 of the storage apparatus 12, for example. Further, the engagement may be simply a bearing contact, which provides a reaction force predominately along one axis and, hence, acts as a guide, or may be a mechanical coupling that provides reaction forces along two or more axes and, hence, retrains the stabilizing member 18 relative to the storage apparatus.

For example, stabilizing member 18 may have one or more guide rollers 18a (FIG. 2) to engage the frame 20 or rail 22 to guide the stabilizing member 18 relative to the storage apparatus 12. In one embodiment, the storage apparatus 12 may be configured with an EXOTEC® rack structure with vertical rack guides, which could be engaged by the guide rollers to stabilize the automated load handling device 14.

In another example, when the automated load handling device 14 is positioned in an aisle between two storage apparatuses 12, such as in an automated storage and retrieval system (ASRS) or a Dematic MULTISHUTTLE® rack system, automated load handling device 14 may have two stabilizing members 18 that extend outwardly from opposed sides of the extendible load support (a robotic arm or fork, for example) and extend to the respective two storage apparatuses to form a brace and, thereby, stabilize the automated load handling device 14. When forming a brace, each respective stabilizing member 18 may include a pad at its distal end to provide a bearing contact with the respective storage apparatus. Further, the stabilizing members 18 may be sized and extended to generate compression forces on the respective storage apparatus.

Referring again to FIGS. 1 and 2, the stabilizing member or members 18 may be mounted to the extendable load support 16. The stabilizing member or members 18 may have a fixed length or be formed from a telescoping member. Further, stabilizing member or members 18 may be moved relative to the extendible load support, such as by pivoted or linearly extending from the extendable load support 16 mechanically (e.g. using linkages or gears and rack or springs), pneumatically (e.g. using a cylinder), electromechanically (e.g. using an actuator, such as a linear actuator or motor), or using magnetic devices (e.g. an electromagnetic that is controlled by the control system of the automated load handling device 14, such as described below).

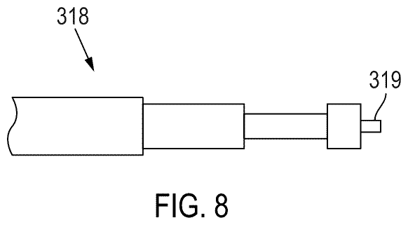

In addition or alternatively, in any of the above, stabilizing member 18 may include a locking mechanism to grab the respective storage apparatus, and hence provide reaction forces along at least two axes, such as via a gripper. A suitable locking mechanism may include a deployable pin that is mounted to the distal end of the stabilizing member 18, which is configured to releasably engage an engagement structure on the respective storage apparatus, such as a bin position hole in the storage apparatus. For example, the pin may be moved from a stowed position to a deployed, operable position, where it engages the respective storage apparatus, by a driver, such a solenoid or an electromagnet or pneumatic device. In one form, the pin may be extended linearly. Alternately, the pin could rotate from its stowed position to its deployed, operable position. An exemplary telescoping stabilizer or stabilizing arm 318 is illustrated in FIG. 8 having an extendable and retractable pin 319, where pin 319 may engage within apertures on a rail, such as rail 22.

To selectively control the deployment of control stabilizing member 18 and optional locking pin, automated load handling device 14 may include one or more sensors 24. Sensors 24 may be provided to detect the proximity of the storage apparatus, and based on a signal from the sensor (or alternately the state of the sensor) the control system described below will generate actuating signals to the driver of the stabilizing member 18 and of the optional locking pin so that the stabilizing member 18 is moved or extended to its deployed position, and similarly the pin is moved or extended to an extended, operative position for engagement with the storage apparatus. The proximity detection device 24 that is configured to detect when the automated load handling device 14 is in close proximity to the storage apparatus 12 may be constructed as an of a number of different types of sensors, such as a capacitive sensing device, sonar device, or any other sensing technology suitable for the material handling system 10.

As noted above, the automated load handling device 14 may take various forms, including an automated mobile robot (AMR), an automatic guided vehicle (AGV), an advanced motor control system (ACR) a humanoid, a robotic device with moveable arm, as well as a forklift. In the depicted embodiment of FIGS. 1 and 2, automated load handling device 14 is illustrated as an AMR 26 with a base 28 and a robotic arm 30, which is mounted to base and for movement about a vertical axis 28a. While the robotic arm 30 is capable of various applications, it is particularly useful in carrying out the various techniques disclosed in commonly assigned International Patent Application Publication No. WO 2015/035300 entitled AUTONOMOUS MOBILE PICKING, the disclosure of which is hereby incorporated herein by reference in its entirety.

Robotic arm 30 includes two articulating arms 30a, 30b, which are configured to pivot about pivot axes 32a, 32b. The robotic arm 30 has an end of arm tool 30c that may be used to grasp and manipulate articles and is interchangeable with other tools at a tool changing station. The robotic arm 30 may include a vison system, such as a camera, that detects objects to allow end of arm tool 30c to grasp and manipulate the objects.

Robot arm 30 may have an onboard controller 60 to control the movement of arms 30a, 30b, which is in communication with the control or control system 50 of AMR 26, or may be controlled directly by the control 50 of AMR 26. Thus the robotic control 60 may be substantially autonomous with respect to the control 50. Both the AMR 26 and the robotic arm 30 may be operated autonomously or in response to instructions received from a central off-vehicle control (not shown), such as by RF or other forms of communication. By having the robotic control 60 be autonomous from the control 50, the process of picking and placing an article is separated from the process of positioning the robotic arm at a location where the picking and placing can occur.

In addition, robotic arm 30 may include the one or more stabilizing members 18, with one on each side of arm 30b. Optionally, as noted, each stabilizing member 18 may be formed from a telescoping member or from a fixed length member, which is deployed by either on board controller or by the AMR control system directly. Similarly, as noted above, sensor or sensors 24 may be mounted to robotic arm 30, for example, in articulating arm 30b as shown, which provides input directly or indirectly to the control system of AMR 26.

To move the AMR across a floor, AMR 26 has a propulsion system to propel and steer the AGV. For example, base 28 of AMR 26 may have two or three or more wheels 34, such as caster wheels, to support base 28 above the floor, with at least one of the wheels forming a drive wheel and biased against the floor to propel the AMR across the floor.

Further, as noted, material handling system 10 includes a control 50 with a navigation and guidance system 52, which is capable of determining precisely the position and orientation of AGV 26 and controlling the position and orientation of the AGV 26 to follow a preferred trajectory, also known as a guide-path. Control 50 includes forward-facing and rearward-facing light imaging, detection and ranging (LIDAR) systems 54 in order to detect features around AMR 26 and direction and distance to the features. Additionally, control 50 may receive inputs from sensors 24 and the vision system and directly control the drivers of robotic arm 30, stabilizing member 18, arm tool 30c, and/or optional locking pin or may control them via onboard controller 60 provided for robotic arm 30. For further details of base 28, wheels 34, the base housing, and navigation and guidance system 50, control 60, reference is made to U.S. Pat. No. 10,434,924, which is commonly owned by Dematic Corp. of Grand Rapids, MI and which is incorporated by reference herein in its entirety.

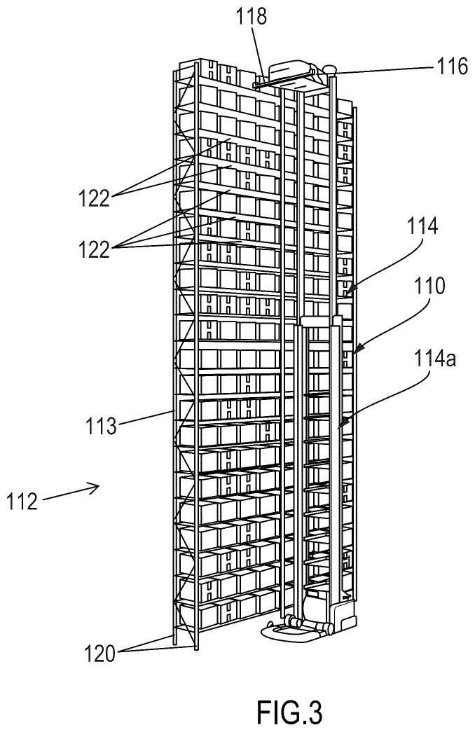

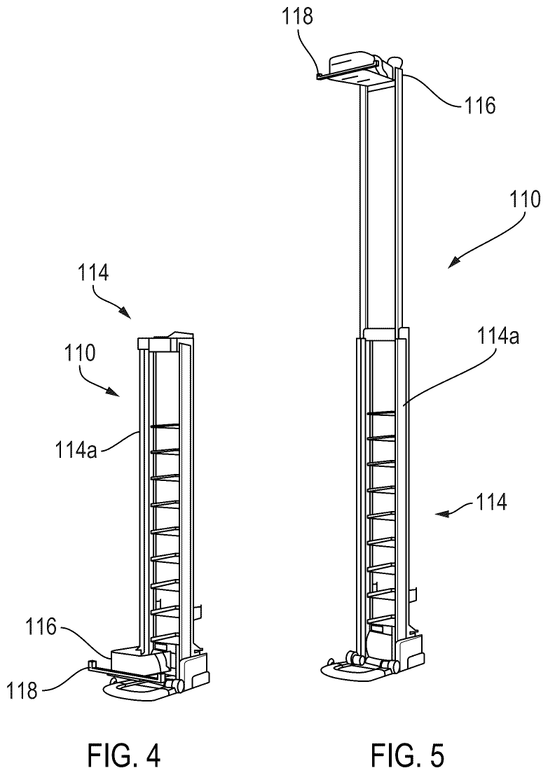

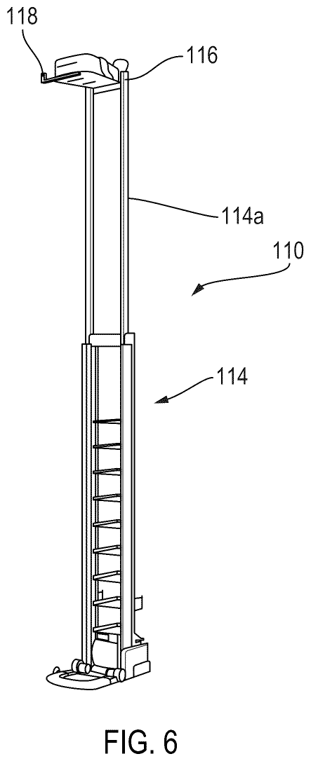

As noted above, referring to FIGS. 3-6, an alternative material handling system 110 and automated load handling device 114 may take various forms including an AMR 114 with an extendible load support in the form of a shuttle 116 mounted for vertical movement on a telescoping frame 114a. Similar to the previous embodiment, shuttle 116 may incorporate one or more stabilizers or stabilizing members 118 (FIGS. 5 and 6) that extend from the extendible load support, in this embodiment shuttle 116. As shown, AMR 114 is useable with a storage apparatus 112 comprising a storage rack 113 having a frame 120 and rails 122 that are engageable by a stabilizing member 118.

As best seen in FIG. 5, shuttle 116 includes two stabilizing members 118 that extend outwardly from opposed sides of shuttle 116 and extend, for example, between two storage apparatuses 112 (only one shown in FIG. 3) to form a brace and, thereby, stabilize the automated load handling device 114 between the two storage apparatuses 112.

Similar to automated load handling device 14, automated load handling device 114 may have an onboard controller to control the movement of shuttle 116 and its extendible arms, as well as stabilizing members 118. To move automated load handling device 114 across a floor, automated load handling device 114 may have a propulsion system to propel and steer the automated load handling device 114, similar to automated load handling device 10. For example, the base of automated load handling device 114 may have two or three or more wheels, such as caster wheels, to support the base above the floor, with at least one of the wheels forming a drive wheel and biased against the floor to propel the automated load handling device 114 across the floor.

For further details regarding the stabilizing members, optional sensors, and how they can be mounted to shuttle 116, as well as optional control systems and navigation systems, reference is made to the above description regarding automated load handling device 14 with extendable load support 16.

Referring to FIG. 7, the numeral 210 designates yet another embodiment of a material handling system having an automated load handling device in the form of a telescoping forklift 214 with an extendible load support in the form of a fork 216 that is mounted to a telescoping frame 214a that extends to raise or lower fork 216. Similar to the previous embodiment, fork 216 may incorporate one or more stabilizing members 218 that extend from the extendible load support, in this embodiment fork 216. As shown, telescoping forklift 214 is useable with storage apparatuses 212 comprising storage racks 213 that each include a frame 220 and rails 222 that are engageable by stabilizing members 218

As best seen in FIG. 7, fork 216 includes two stabilizers or stabilizing members 218 that extend outwardly, for example, from opposed sides of fork 216 and extend, for example, between two storage apparatuses 212 to form a brace and, thereby, stabilize the telescoping forklift 214 between the two storage apparatuses 212. However, as noted above, only a single stabilizing member 218 may be deployed to engage only one of the racks.

Similar to automated load handling devices 14 and 114, automated load handling device 214 may have an onboard controller to control the movement of fork 216, as well as stabilizing members 218. To move automated load handling device 214 across a floor, automated load handling device 214 may have a propulsion system to propel and steer the automated load handling device 214, similar to automated load handling devices 14 and 114. For example, the base of automated load handling device 214 may have two or three or more wheels, such as caster wheels, to support the base above the floor, with at least one of the wheels forming a drive wheel and biased against the floor to propel the automated load handling device 214 across the floor. For further details regarding stabilizing members 218, optional sensors, and how they can be mounted to fork 216, as well as optional control systems and navigation systems, reference is made to the above description.

The onboard computer, control system, navigation and guidance system, vision system described with reference to the figures herein may generally comprise a processor configured to perform computations and control the functions of the system, including executing instructions included in computer code for the tools and programs capable of implementing methods for managing automatic load handling device and storage systems of a warehouse for order fulfillment, in accordance with some embodiments, wherein the instructions of the computer code may be executed by the processor via a memory device or memory module. The computer code may include software or program instructions that may implement one or more algorithms for implementing one or more of the foregoing methods. The onboard computer, control system, navigation and guidance system, vision system execute the computer code can be any processor such as a vision processing unit (VPU), a Tensor processing unit (TPU), a digital signal processor (DSP), a general purpose core processor, a graphical processing unit (GPU), a computer processing unit (CPU), a field programmable gate array (FPGA), an artificial intelligence-application specific integrated circuit (AI-ASIC), a microprocessor, an AI/ML processing unit, a crypto-processor unit, an neural processing unit, a cognitive computing unit, a silicon-on-chip, a graphene-on-chip, a neural network-on-chip, a neuromorphic chip (NeuRRAM), a system on a chip (SoC), a system-in-package (SIP) configuration, either single-core or multi-core processor, or any suitable combination of components. Other purpose-built processor suitable for AI and Internet-of-Things (IOT) computing may also be suitable for the above-described systems. A virtual processor can be formed as a portion of the controller, the controller module, PLC, WES.

The memory device or memory module may include input data. The input data includes any inputs required by the computer code. The output device displays output from the computer code. A memory device may be used as a computer usable storage medium (or program storage device) having a computer-readable program embodied therein and/or having other data stored therein, wherein the computer-readable program comprises the computer code. Generally, a computer program product (or, alternatively, an article of manufacture) of the system may comprise said computer usable storage medium (or said program storage device).

The network between the onboard computer, control system, sensors, and so forth may include wired communication, wireless communication, or combination thereof. Wireless communication can include, but not limited to, wireless local area network (WLAN), a wireless wide area network, local area network (LAN), personal area network (PAN), a cloud-based network, public network (e.g. the Internet), private network (e.g. frame-relay network), cable network, short and long range radio and wireless communication protocols, such as Bluetooth, low energy Bluetooth, zigbee, infrared, and radio frequency, a wireless fidelity network (WiFi), ultra-wide band (UWB), a wireless mesh network, a cellular network, a satellite network, mobile ad-hoc network (MANET), long term evolution (LTE) network, worldwide interoperability for microwave access (WiMAX), universal mobile telecommunication system, (UMTS), and the like, or any combination suitable for the environment.

As will be appreciated by one skilled in the art, the disclosure may be a computer program product. Any of the components of the embodiments of the disclosure can be deployed, managed, serviced, etc. by a service provider that offers to deploy or integrate computing infrastructure with respect to embodiments of the inventive concepts. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s), wherein the processor(s) carry out instructions contained in the computer code causing the computer system for generating a technique described with respect to embodiments. In another embodiment, the disclosure discloses a process for supporting computer infrastructure, where the process includes integrating computer-readable program code into a computer system including a processor.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the system and the automated load handling device described herein. It is understood that any and all embodiments of the system and the automated load handling device described may be taken in conjunction with any other features and embodiments noted herein. Furthermore, any element of an embodiment may be combined with any and all other elements of any of the additional embodiments noted herein.

1. A material handling system comprising:
a storage apparatus having a frame and a plurality of storage shelves, said frame configured to support the plurality of storage shelves on a floor; and
an automated load handling device having a base configured to be a supported on and for movement across the floor, said automated load handling device including a stabilizing member configured to engage the storage apparatus to stabilize the automated load handling device.

2. The material handling system according to claim 1, said automated load handling device further including an extendible load support that is extendible or movable relative to said base.

3. The material handling system of claim 2, wherein said stabilizing member is mounted relative to said extendible load support to move with said extendible load support.

4. The material handling system according to claim 3, wherein said stabilizing member is movably mounted to said extendible load support and is movable between a stowed position and a deployed position where it is configured to engage said storage apparatus.

5. The material handling system according to claim 1, wherein said storage apparatus includes a rail mounted relative to said frame of said storage apparatus, and wherein said stabilizing member is configured to engage said rail.

6. The material handling system according to claim 1, wherein said stabilizing member is configured to couple to said storage apparatus.

7. The material handling system according to claim 1, wherein said stabilizing member supports a lock to releasably lock said stabilizing member to said storage apparatus.

8. The material handling system according to claim 2, wherein said extendible load support comprises a robotic arm.

9. The material handling system of claim 1, wherein said storage apparatus comprises a pair of storage apparatuses separated by an aisle, and wherein said automated load handling device is configured to traverse said aisle between said storage apparatuses with said stabilizing member configured to engage at least one of the storage apparatuses to stabilize the automated load handling device.

10. The material handling system of claim 9, wherein said automated load handling device comprises a pair of said stabilizing members, and wherein each said stabilizing member is configured to engage a separate one of said storage apparatuses.

11. A method of stabilizing a load handling device in position adjacent an adjacent storage apparatus, said method comprising:
providing the load handling device with at least one stabilizing member;
positioning the stabilizing member to contact the adjacent storage apparatus or another storage apparatus next to the adjacent storage apparatus; and
contacting the adjacent storage apparatus or other storage apparatus with the stabilizing member to facilitate stabilizing the load handling device.

12. The method of claim 11, wherein said positioning includes pivoting the stabilizing member between a stowed position and a deployed position where the stabilizing member is positioned to contact the storage apparatus.

13. The method of claim 11, wherein said positioning includes extending the length of the stabilizing member.

14. The method of claim 11, wherein said contacting includes engaging the adjacent storage apparatus or other storage apparatus with the stabilizing member.

15. The method of claim 14, further comprising providing a rail on the adjacent storage apparatus or other storage apparatus, and said engaging includes engaging the rail with the stabilizing member.

16. The method of claim 15, wherein said engaging includes locking the stabilizing member to the adjacent storage apparatus or other storage apparatus.

17. A method of stabilizing a load handling device, the load handling device being located between two opposed storage apparatuses, said method comprising:
providing the load handling device with at least one stabilizing member;
positioning the stabilizing member to contact one of the opposed storage apparatus; and
contacting the one of the opposed storage apparatuses with the stabilizing member to facilitate stabilizing the load handling device.

18. The method of claim 17, wherein said providing includes the load handling device with two stabilizing members, and said contacting includes contacting both opposed storage apparatuses with the stabilizing members.

19. The method of claim 18, wherein said contacting includes engaging at least one of the opposed storage apparatuses.
